(19) United States
(12) Patent Application Publication
(10) Pub. No.: US 2003/0158888 A1
(43) Pub. Date: Aug. 21, 2003

(54) Safe communication

(76) Inventors: Magnus Bjorklund, (US); Petter Ericson, (US); Marianne Lindstrom, (US); Martin Sandstrom, (US)

Correspondence Address: BIRCH STEWART KOLASCH & BIRCH, PO BOX 747, FALLS CHURCH, VA, 22040-0747, US

(21) Appl. No.: 10/322,446

(22) Filed: Dec. 19, 2002

Related U.S. Application Data
(60) Provisional application No. 60/344,357, filed on Jan. 4, 2002.

(30) Foreign Application Priority Data
Dec. 28, 2001 (SE) 0104444-5

(51) Int. Cl. G06F 15/16

(52) U.S. Cl. 709/201

(57) ABSTRACT

The present invention relates to a method in connection with transfer of information, a system and a computer-readable medium storing computer-readable components for transfer of information. The invention is based on the idea that a user telecommunication address is associated with a temporary telecommunication address. The temporary address, designating the server, is then sent to a service handler. The service handler sends information to said temporary telecommunication address. The server knows the coupling between the temporary address and the user address, and forwards the service handler information to the user address. By employing this concept, it is not possible for a service handler to send information directly to the user telecommunication address, since the service handler does not know said user address, but must send its information to the user address via the server, which knows the coupling between the temporary telecommunication address and the user telecommunication address.

### TECHNICAL FILED OF THE INVENTION

The present invention relates to a method in connection with transfer of information, a system for transfer of information and a computer-readable medium for storing computer-executable components for transferring information employing said method.

### BACKGROUND ART

Traditionally, information is written and distributed by means of pen and paper. However, such paper-based information is difficult to manage and communicate in an efficient way.

Computers are to an ever-increasing extent used for management and communication of information. The information is typically input by means of a keyboard and stored in the computer memory, for example on a hard disk. However, it is a slow process to input information with a keyboard, and there is a significant risk of errors occurring in the process. Graphic information, such as drawings and images, is normally fed to the computer through a separate device, such as a scanner or the like. The process of feeding such information to the computer is time consuming, lengthy, and often yields unsatisfactory results. When the information eventually is located in the computer, it can easily be communicated to others, for example as an e-mail or SMS via an Internet connection, or as a fax via a fax modem.

The present Applicant has proposed a remedy to this problem in the international application WO 01/16691, which is incorporated herein by this reference and in which the Applicant envisages the use of a product having a writing surface which is provided with a position code. The position code, which codes a plurality of positions on the surface, enables electronic recording of information that is being written on the writing surface. The information is written on the surface by means of a digital pen. The pen has a sensor, which detects the position code on the surface. The pen records information by recording the detected position code. The position code is capable of coding coordinates of a large number of positions, much larger than the number of necessary positions on one single product. Thus, the position code can be seen as forming a virtual surface, which is defined by all positions that the position code is capable of coding, different positions on the virtual surface being dedicated for different functions and/or actors. The pen communicates with a server with knowledge of the functionality of every position on the virtual surface and any actor associated with each such position.

The above concept can be used for a number of different purposes. The combination of pen and position coded product can be used as an input device to a computer, a PDA, a mobile phone or the like. For example, text and sketches written on a position-coded notepad can be transferred via the pen to a computer. Additionally, the combination of pen and position-coded product allows for global communication, directly from the product via the pen, by the position code on the product being dedicated for such communication. For example, the information registered by the pen can be transformed to a fax message, an e-mail or an SMS, and then be sent from the pen to a recipient. Further, the combination of pen and position-coded product can be used in e-commerce. For example, the digital pen can be used to order an item from a position-coded advertisement in a magazine, by the position code in the advertisement being dedicated for such a service.

When the digital pen is used to order an item from an advertisement in a magazine, or if the digital pen is used to mark an advertisement to, for example, receive additional information about an item, the service handler providing the item or the information will require the e-mail address of the user of the digital pen or some other telecommunication address information such as a phone number or a fax number. A common problem associated with the issuing of this type of information is the risk of, in case of giving away an e-mail address, receiving junk mails, such as unwanted advertisements, undesired product information and the like, from the recipient of the e-mail address. The recipient of the address, e.g. a company, could possibly also distribute or sell the e-mail address to other companies, organizations or establishments. Needless to say, a pen user might feel uncomfortable to give away his/her e-mail address or other address information due to the risk of receiving unwanted mail or due to the risk of other types of misuse. Of course, the process of giving away address information, such as an e-mail address, should be as automated as possible. In existing solutions, the user must log on to a specific server by entering a username and a corresponding password and instruct the server to generate an alias e-mail address. This generated alias e-mail address must then be copied from an alias e-mail field, or the server can be instructed to send the alias e-mail address to the true e-mail address of the user. This alias e-mail address is then provided to said service handler. As can be seen from the above, this existing solution requires some manual work and it also takes some time to log on to a server and generate the alias e-mail address. Besides, when the user of the digital pen is filling in the ad, it is not at all certain that said user has access to a computer for logging on to the specific server which generates the alias e-mail address.

A problem that has to be solved is that a user, in a simple and automated manner, must be able to give away his/her e-mail address without the risk of receiving junk mail or without the risk of being subjected to e-mail address misuse. This problem is present for other telecommunication addresses as well, such as phone or fax numbers.

### SUMMARY OF THE INVENTION

An object of the present invention is therefore to provide a solution to the above given problem.

This object is solved by a method in connection with transfer of information according to claim 1, a system for transfer of information according to claim 16 and a computer-readable medium storing computer-executable components in accordance with claim 28. Preferred embodiments are defined by the dependent claims.

According to a first aspect of the invention, a method is provided where a temporary, generated telecommunication address is sent, based on user unit information data, to a service handler. The generated telecommunication address designates a server to which the service handler sends information, which information is forwarded to a true user telecommunication address associated with the generated telecommunication address, wherein the service handler is unable to send information directly to the true user telecommunication address.

According to a second aspect of the invention, a system is provided comprising at least one user unit and at least one server, which system sends, based on user unit information data, a temporary, generated telecommunication address to a service handler The generated telecommunication address designates said server to which the service handler sends information, which information is forwarded to a true user telecommunication address associated with the generated telecommunication address, wherein the service handler is unable to send information directly to the true user telecommunication address.

The invention is based on the idea that user unit information data is transferred to a service handler following a marking, by means of a user unit, of an activation icon on a position coded surface. Based on these information data, a temporary, generated telecommunication address is sent along with the information data. User unit information data can be data related to the position coded surface, i.e. data resulting from what is actually being written on the position coded surface, or where this is written, and recorded by the user unit. Information data can also be prestored data such as, for example, e-mail addresses, credit card numbers, different user unit properties or data associated with a certain area of the position coded surface. This temporary, generated telecommunication address, such as a temporary e-mail address, of a user (hereinafter referred to as “the user”) of the user unit is associated with a true user e-mail address and the temporary e-mail address is then sent to a service handler, so that the service handler can contact the user. In case of an application with temporary e-mail addresses, information is sent from the service handler to the generated address, designating a safe e-mail server, where the generated e-mail address of the user is coupled to the true e-mail address of the user. The safe e-mail server thus forwards the information of the service handler to the true e-mail address.

By employing this method, it is not possible for a service handler to send e-mail directly to the user, since the service handler does not know the true e-mail address of the user. It must send information via the safe e-mail server, since this server knows the coupling between the generated address and the true address of the user. Neither is it meaningful for the service handler to sell or further distribute said generated e-mail address. Moreover, this method does not require manual work for the user, such as logging on to a server by entering a username and a corresponding password and instructing the server to generate an alias e-mail address, since the process of sending the generated address to a service handler is completely automated from a user point of view. The fact that information data is sent by marking, by means of the user unit, the activation icon on the position coded surface makes communication smooth for the user.

According to an embodiment of the invention, the generated e-mail address is sent from the safe e-mail server to a service handler. The true e-mail address is extracted at the server, either by text recognition of the information data sent from the user unit to the server or by actually including a true e-mail address in the user unit, as a property, and sending this property to the server.

If the address is extracted by text recognition, a user can state any e-mail address, by writing down said e-mail address in the advertisement, to which the information should be sent. One scenario is that, for example, a family owns a user unit collectively. When each member in the family uses the pen, respectively, the e-mail property of the user unit does not have to be changed every time the user unit is switched between family members. This is very useful as soon as a group of people wants to use the same pen.

If, on the other hand, the e-mail address is included in the user unit as a property, the server does not have to employ text recognition to extract the e-mail address. Neither is it necessary for the user of the user unit to actually fill in his/her true e-mail address in an advertisement, since the e-mail address property, in which property the true user e-mail address is included, is sent to the safe e-mail server. It could also be the case that the user has a some kind of subscription with a certain safe e-mail server, in which case the safe e-mail server knows the true user e-mail address, for example by checking a user unit identifier which is sent from the user unit to the server.

According to another embodiment of the invention, each time a user unit without a generated e-mail address connects to a server (also known as the paper look-up server) with knowledge of the functionality of every position on the virtual surface and any actor associated with each such position, the user unit is automatically updated with a generated e-mail address. This generated address is then sent to a service handler. The coupling between the generated e-mail address and the true user e-mail address is stored in a safe e-mail server database. This database is not necessarily located at the paper look-up server. The paper look-up server most likely communicates with a number of different databases. For example, different operators could use different safe e-mail databases. In this case, where the paper look-up server provides the generated e-mail address, it is not necessary for the user unit to send the true e-mail address to the paper look-up server, since the paper look-up server already knows the true e-mail address. The paper look-up server has access to a database containing information concerning all the user units in the system.

According to yet another embodiment of the invention, the user unit associates the true address with a temporary, generated address by encrypting the true address, wherein the temporary address comprises the encrypted true address of the user. A user unit identifier is sent along with the generated address, creating an address information “ticket”. This ticket is sent to a service handler. For the service handler to know where to send the service handler information, the e-mail address of the safe e-mail server is included in the ticket. The service handler sends information to the safe e-mail server as described earlier, but now also sends the ticket to the safe e-mail server. The server uses the user unit identifier to fetch (from a storage medium, such as a database) the safe e-mail server decryption key that corresponds to the user unit encryption key. The server decrypts the encrypted true user e-mail address, thereby deriving the true e-mail address from the generated address. The safe e-mail server forwards the service handler information to the true e-mail address. This embodiment has the advantage that neither the safe e-mail server, nor the paper look-up server, needs to produce a temporary e-mail address and store the coupling between the true and the generated e-mail address.

According to further embodiments of the invention, the aforementioned ticket is provided with a timestamp. If someone would eavesdrop on the network and capture a copy of the ticket, it would be possible for the eavesdropper to use the ticket for communication with a true user e-mail address via a safe e-mail server. With the timestamp, it is possible to have a predetermined limited period of time, a lifetime, during which period of time the ticket is valid. If this lifetime is short enough, it is not likely that an eavesdropper manages to use the ticket within the limited time period, even if the eavesdropper would capture the ticket. The ticket can also be provided with a unique ticket identifier. This unique identifier prevents ill-intentioned third parties to copy the ticket. With the unique identifier, it is possible to see if the ticket has been in use in the system.

According to yet further embodiments of the invention, the association of the generated e-mail address with the true user unit address is valid for a limited number of occasions of forwarding information from the safe e-mail server to the true user e-mail address. Sometimes it is desirable that the service handler can send information one time to the true user e-mail address. Other times it might be desirable to allow the service handler to send more than one roundtrip of information. It is possible to have a variable property in the user unit, which property can be sent to the safe e-mail server, instructing the server how many times the association of a generated address with a true address is valid. It could also be possible to send a command from the user unit to the safe e-mail server, instructing the server to deactivate the association of the generated address with the true address, if necessary. This can be done at any time, no matter how many allowed roundtrips of information that have been specified earlier.

According to another embodiment of the present invention, a new generated e-mail address is automatically associated with a true user e-mail address as soon as the previous association of a generated e-mail address with the true user e-mail address is invalid. This makes the generation of a temporary e-mail address and the association of this generated e-mail address with a true user e-mail address automated to a great extent.

Further features of, and advantages with, the present invention will become apparent when studying the appended claims and the following description.

### BRIEF DESCRIPTION OF THE DRAWINGS

Embodiments of the present invention will be described with reference to the accompanying drawings, in which:

FIG. 1 shows a system for management and communication of information in which the present invention advantageously may be applied;

FIG. 2 shows an embodiment of the present invention, in which embodiment the generated e-mail address is sent from the safe e-mail server to the service handler;

FIG. 3 shows an embodiment in which the generated e-mail address is sent from the paper look-up server to the service handler via the digital pen; and

FIG. 4 shows an embodiment of the present invention, in which the generated e-mail address, herein including an encrypted true user e-mail address, is sent from the digital pen to the service handler.

### DESCRIPTION OF PREFERRED EMBODIMENTS OF THE INVENTION

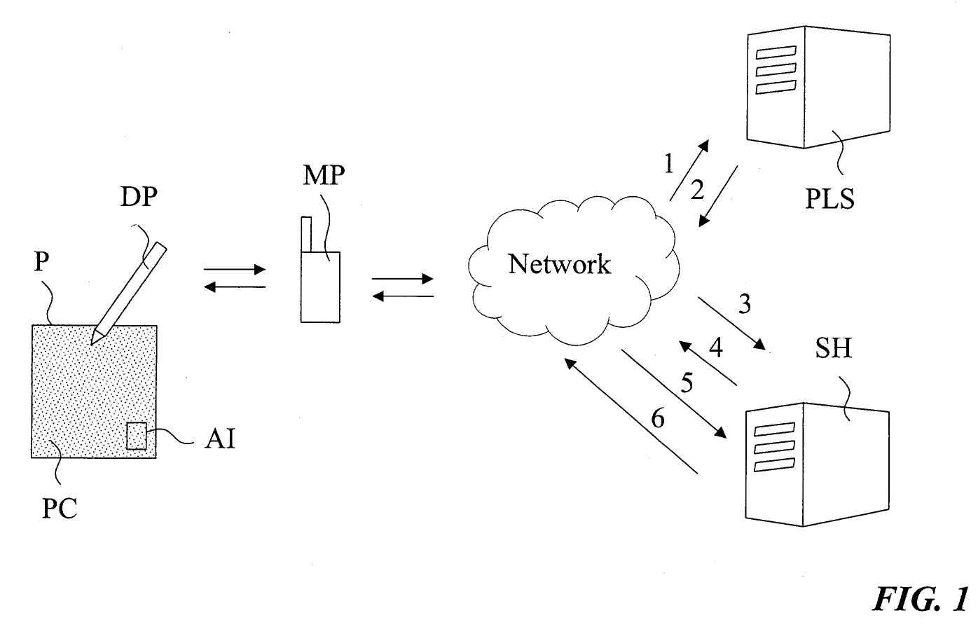

A system for management and communication of information is shown in FIG. 1. Such a system is further disclosed in the Applicant's international patent applications PCT/SE00/02640, PCT/SE00/02641, and PCT/SE00/02659, which applications are incorporated herein by reference. The system of FIG. 1 comprises a plurality of user units in the form of digital pens DP, a plurality of products P with a position code PC, an authentication server in the form of a paper look-up server PLS executing a paper look-up service, and a plurality of service handler units SH. The paper look-up service comprises one or more servers communicating with a database containing the virtual surface formed by the position code and information related thereto. This virtual surface contains all positions that the position code is capable of coding and the functionality of every position on the virtual surface and the actor associated with each such position. The service handler unit SH is a server unit effecting a service, such as storing or relaying digital information, or initiating transmission of information or items to a recipient. In the example hereinabove, the user unit is in the form of a digital pen, but a user unit could also consist of, for example, a mobile phone, a PDA or a stationary or portable device with computing possibilities. Furthermore, it is understood that these exemplified devices could be merged into one single device.

When the digital pen DP is operated to mark an activation icon AI on the position-coded product P, the pen DP initiates an operation to forward a message to the paper look-up server PLS (step 1), for example via short-range radio transmission, or wire, to a mobile phone MP acting as a modem for connection to the paper look-up server PLS. Alternatively, the modem could consist of a PDA, a laptop, a computer, a fax modem or the like. The message contains a unique pen identifier and at least one position from the digital information that has been recorded electronically on the writing surface of the product P. Based on the position content of the message, the paper look-up server PLS instructs the digital pen DP to contact a specific service handler unit SH (step 2). The pen DP then sends a message to the service handler unit SH (step 3), which instructs the pen DP on what data to send, and how to format and tag that data (step 4). After having received the requested data from the pen DP (step 5), the service handler unit SH returns a verification thereof to the pen DP (step 6).

Preferred embodiments of the present invention will be described in the following with reference to the accompanying figures.

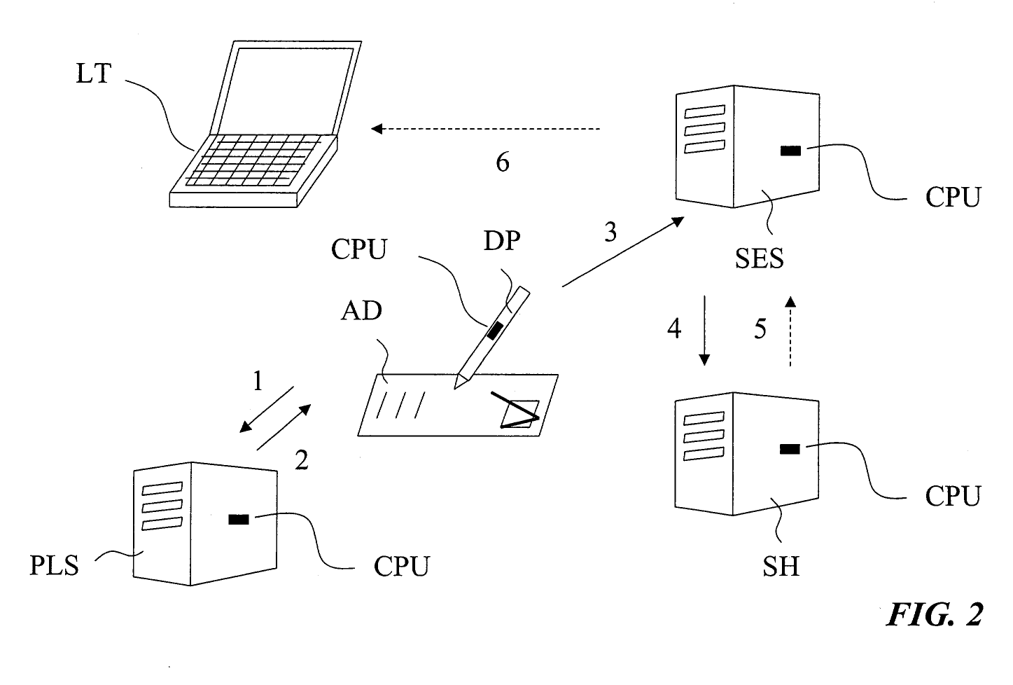

FIG. 2 shows an embodiment of the invention, in which embodiment a user requests information from a service handler SH by writing on an advertisement AD of the service handler, i.e. by marking the activation icon with a digital pen. The digital pen DP contacts a paper look-up server PLS (step 1), which PLS knows which safe e-mail server SES and service handler SH the pen should contact by analyzing the position code. The PLS returns the address of the safe e-mail server SES and the service handler SH to the pen (step 2), and also instructs the pen DP what information it should send, for example a page identifier, since the service handler SH might provide a number of different advertisement pages. The user e-mail address or some other type of telecommunication address, such as a phone number or a fax number, as well as said page identifier and information (for example an e-mail address or a URL) identifying the service handler SH, is sent to the safe e-mail server SES from the digital pen DP (step 3). The safe e-mail server SES generates a temporary e-mail address and stores this generated address together with the true user e-mail address, that is the actual e-mail address of the user of the digital pen, associating the addresses to each other. The generated e-mail address is sent to the service handler SH (step 4) along with the page identifier. The service handler SH sends the requested information to the generated e-mail address, which e-mail address designates the safe e-mail server SES (step 5). The SES associates the generated e-mail address with the true e-mail address of the pen user and forwards the requested information to the true user e-mail address (step 6), which requested information can be viewed on, for example, a laptop LT. Note that steps 5 and 6 comprise e-mail type communication. Depending on an association property instructing the SES how many times the association of the generated address with the true address is valid for forwarding information from the safe e-mail server to the true user e-mail address, the SES can deactivate the association. If, for example, the default value of the association property is “one”, the SES will deactivate the association of a generated address with the true address once information has been forwarded one time. This makes it impossible for the service handler to send any more e-mails to the true user e-mail address.

As clearly understood by those of ordinary skill in the art, the different steps described with reference to FIG. 2 is performed by a microprocessor CPU, or some equivalent thereof, for example an ASIC or some other programmable hardware, having computing capability, arranged in the pen DP, the safe e-mail server SES and the service handler SH, respectively. Consequently, the means included by the system of the invention is implemented by this CPU or its equivalent, which is arranged to perform the function of said means when executing appropriate software code. This of course applies to the other embodiments as well.

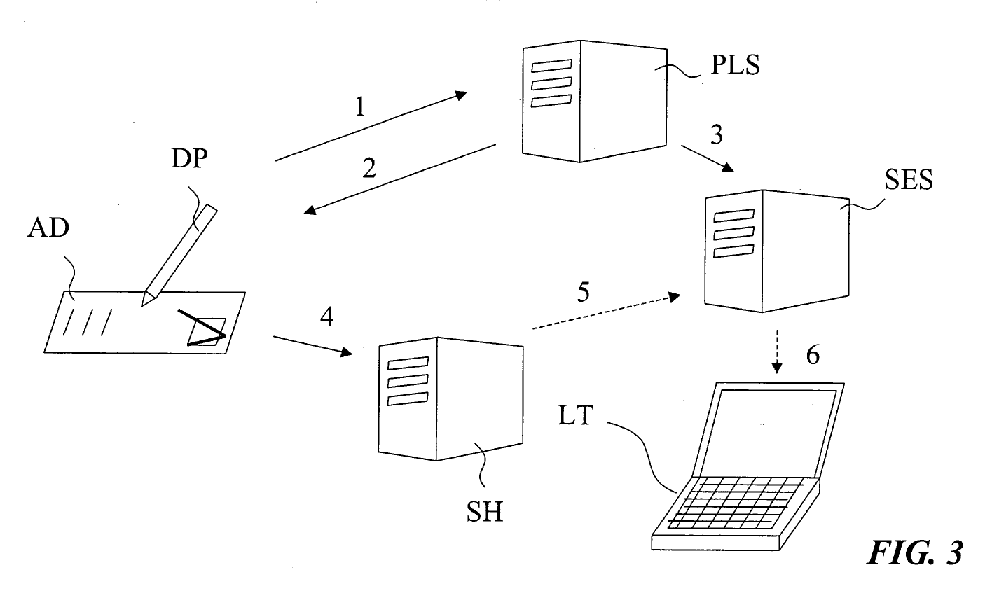

FIG. 3 shows another embodiment of the invention, in which at least one generated temporary e-mail address is stored in the pen DP. Each time a pen DP without a generated temporary e-mail address connects to the paper look-up server PLS (step 1), the pen is automatically updated with at least one generated e-mail address (step 2), which generated e-mail address is stored together with the true e-mail address of the user in the safe e-mail server SES (step 3). Note that the SES is not necessarily located at the PLS.

The user requests information from a service handler SH by writing on an advertisement AD of the service handler. The generated temporary e-mail address received from the PLS is sent to the service handler SH from the digital pen DP (step 4). The service handler SH sends information to the generated address, which address designates the safe e-mail server SES (step 5). The SES derives the true e-mail address of the pen user from the generated e-mail address and forwards the service handler information to the true e-mail address of the pen user (step 6), which service handler information can be viewed on, for example, a laptop LT. Note that steps 5 and 6 comprise e-mail type communication. In the case where the digital pen DP receives the generated temporary e-mail address from the PLS, the pen is automatically updated with at least one new, generated e-mail address as soon as the digital pen DP contacts the PLS the next time.

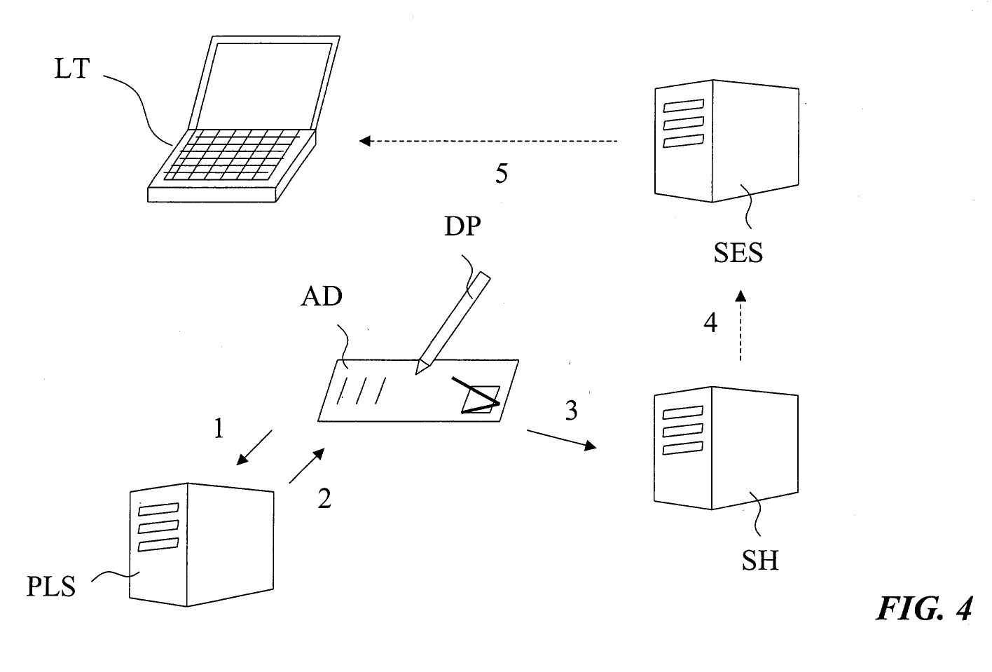

FIG. 4 shows yet another embodiment of the present invention. Again, a user requests information from a service handler SH by writing on an advertisement AD of the-service handler. The digital pen DP contacts the paper look-up server PLS (step 1), which PLS knows which safe e-mail server SES and service handler SH the pen should contact by analyzing the position code, which code comprises at least one position from the digital information that has been recorded electronically on the writing surface of the advertisement AD. The PLS returns the address of the safe e-mail server SES and the service handler SH to the pen (step 2). The generated, temporary address includes in this embodiment at least the encrypted e-mail address of the user. The generated address is provided with the address of the safe e-mail server and the pen identifier, creating the aforementioned address information ticket. The ticket, and possibly also the previously mentioned page identifier, is sent to the service handler SH (step 3), which sends the generated e-mail address and the pen identifier together with requested service handler information to the safe e-mail server SES (step 4). The safe e-mail server fetches the decryption key that corresponds to the encryption key from a decryption key database with the help of the pen identifier. The server then uses this decryption key to decrypt the encrypted true user e-mail address, thereby deriving the true address from the generated address. The safe e-mail server then forwards the service handler information to the true user e-mail address (step 5), which service handler information can be viewed on, for example, a laptop LT. Note that steps 4 and 5 comprise e-mail type communication.

In the embodiment in FIG. 4, the generated e-mail address could be provided with a timestamp to prevent eavesdroppers from using a copy of the generated address. With the timestamp, it is possible to give the generated address a lifetime during which lifetime the generated address is valid. If this lifetime is short enough, it is not likely that an eavesdropper manages to use the generated address within the limited time period, even if the eavesdropper would capture it. The generated address can also be provided with a unique ticket identifier. This unique ticket identifier further prevents eavesdroppers to copy the generated address. With the unique ticket identifier, it is possible to see if the generated address has been in use in the system. If an eavesdropper manages to use a copy of the generated address within the hereinabove described lifetime, the unique ticket identifier can be used to determine whether the generated e-mail address has been used before or not. If the user of the true e-mail address has allowed the safe e-mail server to forward information from a specific service handler only once, the safe e-mail server will decide that the generated e-mail address with the corresponding unique ticket identifier has been used. As a result, the safe e-mail server will not forward the information sent by the eavesdropper.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method in connection with transfer of information, including the steps of:
associating a user telecommunication address with a temporary telecommunication address;
sending, to a service handler, following a marking, by means of a user unit, of an activation icon on a position coded surface, user unit information data and, based on said user unit information data, accompanying said user unit information data with the temporary telecommunication address, wherein said user unit information data comprise data resulting from what is written on the position coded surface and recorded by the user unit or data associated with a certain area of the position coded surface;
receiving, at a server, information from said service handler addressed to said temporary telecommunication address; and
forwarding, from said server, said service handler information to said user telecommunication address.

2. The method according to claim 1, wherein the step of associating is performed at said server.

3. The method according to claim 1 or 2, wherein the step of sending said temporary telecommunication address is performed by a user unit.

4. The method according to claim 1 or 2, wherein the step of sending said temporary telecommunication address is performed by said server.

5. The method according to claim 1, wherein the step of associating is performed at a user unit by encrypting said user telecommunication address, thereby providing the temporary telecommunication address.

6. The method according to claim 5, wherein the step of sending said temporary telecommunication address is performed by a user unit, and includes providing said temporary telecommunication address with a user unit identifier.

7. The method according to claim 6, wherein the temporary telecommunication address is provided with a timestamp.

8. The method according to claim 7, wherein said server checks said timestamp to determine whether said server is allowed to forward the received service handler information to the user telecommunication address.

9. The method according to any of claims 6-8, wherein the temporary telecommunication address is provided with a unique identifier.

10. The method according to claim 9, wherein said server checks said unique identifier to determine whether said server is allowed to forward the received service handler information to the user telecommunication address.

11. The method according to any of claims 5-10, wherein the user telecommunication address is derived from the temporary telecommunication address by decrypting the temporary address.

12. The method according to any of the preceding claims, wherein the association of said user telecommunication address with said temporary telecommunication address is valid for a limited number of occasions of forwarding information from said server to said user telecommunication address.

13. The method according to any of the preceding claims, wherein said user unit is capable of sending a command to said server, which command deactivates the association of said user telecommunication address with said temporary telecommunication address, making the association invalid.

14. The method according to claim 12 or 13, including the step of automatically associating said user telecommunication address with a new temporary telecommunication address when the previous association of said user telecommunication address with said temporary telecommunication address is invalid.

15. The method according to any of the previous claims, wherein said user unit information data comprises data resulting from what is written on a position coded surface, or where this is written on a position coded surface, and recorded by the user unit, or prestored data including e-mail addresses, credit card numbers, different user unit properties or data associated with a certain area of the position coded surface.

16. A system for transfer of information, including
at least one server; and
at least one user unit, wherein
associating means arranged to associate a user telecommunication address with a temporary telecommunication address are included in the server or the user unit;
transmitting means arranged to send, following a marking, by means of said user unit, of an activation icon on a position coded surface, user unit information data to a service handler and, based on said user unit information data accompanying said user unit information data with the temporary telecommunication address which designates said server, are included in the server or the user unit, wherein said user unit information data comprise data resulting from what is written on the position coded surface and recorded by the user unit or data associated with a certain area of the position coded surface;
receiving means arranged to receive information from said service handler are included in said server; and
transmitting means arranged to forward said service handler information to said user telecommunication address are included in said server.

17. The system according to claim 16, wherein the association means at said user unit include encryption means arranged to encrypt said user telecommunication address, thereby providing the temporary telecommunication address, and wherein said association means are arranged to provide the temporary telecommunication address with a user unit identifier.

18. The system according to claim 17, wherein means arranged to provide the temporary telecommunication address with a timestamp are included in said user unit.

19. The system according to claim 18, wherein means arranged to check said timestamp, to determine whether said server is allowed to forward the received service handler information to the user telecommunication address, are included in said server.

20. The system according to any of claims 17-19, wherein means arranged to provide the temporary telecommunication address with a unique identifier are included in said user unit.

21. The system according to claim 20, wherein means arranged to check said unique identifier, to determine whether said server is allowed to forward the received service handler information to the user telecommunication address, are included in said server.

22. The system according to any of claims 17-21, wherein decryption means arranged to derive said user telecommunication address from the temporary telecommunication address, by decrypting the temporary telecommunication address, are included in said server.

23. The system according to any of claims 16-22, wherein the associating means included in said server are arranged to associate said user telecommunication address with said temporary telecommunication address for a limited number of occasions of forwarding information to said user telecommunication address.

24. The system according to any of claims 16-23, wherein the receiving means included in said server are arranged to receive a command, which command deactivates the association of said user telecommunication address with said temporary telecommunication address, making the association invalid.

25. The system according to claim 24, wherein the transmitting means included in said user unit are arranged to send said command, which deactivates the association of said user telecommunication address with said temporary telecommunication address, making the association invalid.

26. The system according to any of claims 23-25, wherein the associating means included in said server or in said user unit are arranged to automatically associate said user telecommunication address with a new temporary telecommunication address, when the previous association of said user telecommunication address with said temporary telecommunication address is invalid.

27. The system according to any of claims 16-26, wherein said user unit information data comprises data resulting from what is written on a position coded surface, or where this is written on a position coded surface, and recorded by the user unit, or prestored data including e-mail addresses, credit card numbers, different user unit properties or data associated with a certain area of the position coded surface.

28. A computer-readable medium storing computer-executable components for causing a unit to perform the steps recited in any one of claims 1-15 when the computer-executable components are run on microprocessor included by the unit.
